(19) United States
(12) Patent Application Publication
(10) Pub. No.: US 2026/0205309 A1
(43) Pub. Date: Jul. 16, 2026

(54) HARDWARE-ANCHORED DAO GOVERNANCE ENGINE WITH QUORUM VERIFICATION AND REGULATORY COMPLIANCE

(71) Applicant: George William Bickerstaff, III, Greenwich, CT (US)

(72) Inventor: George William Bickerstaff, III, Greenwich, CT (US)

(21) Appl. No.: 19/561,427

(22) Filed: Mar. 9, 2026

(51) Int. Cl. H04L 9/32; H04L 9/00; H04L 9/08

(52) U.S. Cl. CPC H04L 9/3247; H04L 9/0852; H04L 9/3213; H04L 9/3218; H04L 9/3239; H04L 9/50; H04L 2209/56

(57) ABSTRACT

Existing DAO governance systems operate entirely in software, allowing majority voters to execute proposals regardless of risk controls, enabling privileged actors to forge compliance logs, and forcing regulators to rely on unverifiable system reports. The present invention addresses these limitations by executing governance-critical logic within Trusted Execution Environments (TEEs), hardware-isolated processor regions inaccessible to operating systems, cloud providers, and blockchain nodes. The architecture introduces five elements: a Multi-TEE Quorum Verification Layer requiring agreement from three independent TEEs before authorization; an On-Chain Attestation Registry preventing counterfeit governance engines; a Regulatory Verification Network enabling independent compliance validation; a Post-Quantum Attestation Layer securing evidence for long-term retention; and Automated Treasury Safeguards including hardware-enforced freezes, circuit breakers, and insurance triggers. When violations are confirmed by quorum, cryptographic keys are destroyed, hardware counters advance, and network isolation activates, making non-compliant execution physically impossible while producing zero-knowledge proofs usable across multiple regulatory frameworks.

### FIELD OF THE INVENTION

The present invention relates to hardware-anchored Trusted Execution Environments applied to decentralized financial governance. More specifically, the invention provides a TEE-resident platform for decentralized autonomous organizations and other decentralized governance systems operating over regulated financial and tokenized asset networks. The platform enforces financial compliance through hardware-level proposal gating, multi-TEE quorum verification, an on-chain attestation registry, a regulatory verification network, automated treasury safeguards, post-quantum attestation and key derivation, AI-driven risk assessment inside enclave-protected memory, atomic risk-state transitions, quantum-resistant provenance ledgers, and zero-knowledge proof evidence formatted for multiple regulatory jurisdictions simultaneously.

### BACKGROUND OF THE INVENTION

Decentralized autonomous organizations now govern tens of billions of dollars in digital asset treasuries, lending protocols, tokenized real-world assets, and cross-border capital. Tokenized real-world assets managed under DAO governance are projected to reach ten to sixteen trillion dollars by 2030 according to major financial institution estimates published at the time of filing. This scale creates an urgent need for governance infrastructure that produces tamper-proof, independently verifiable evidence that compliance rules were followed —not merely assertions that they were.

The core problem with every existing DAO governance system is structural: they all run in software. MakerDAO-style governance contracts, Compound Governor frameworks, Snapshot off-chain voting, and OpenZeppelin Governor implementations enforce governance rules through smart contracts and off-chain servers. A party that accumulates sufficient voting power can execute any proposal regardless of risk model outputs, because no hardware-level mechanism physically prevents it. An infrastructure operator with privileged access to off-chain servers can alter compliance logs, forge audit records, or replay governance events out of sequence. These are not design flaws correctable through better smart contract code—they are fundamental limitations of software execution that no amount of improved governance policy can overcome without hardware-level intervention.

A second critical problem concerns how compliance evidence is generated and verified. In every current DAO governance system, compliance documentation is produced by the governed system and submitted to regulators for review—the regulated entity effectively grades its own work. Regulators have no independent means to confirm that the governance engine that produced the compliance evidence is the authentic, unmodified system, that risk assessments reported are the ones actually computed, or that compliance evidence was not generated before risk enforcement completed. The present invention addresses this gap directly through a Regulatory Verification Network architecture that enables independent third-party validation.

Regulated financial institutions subject to Basel III and IV capital requirements must demonstrate that AI-driven risk models used in governance decisions produced verifiable, tamper-proof outputs. The EU Markets in Crypto-Assets Regulation, effective December 2024, imposes verifiable governance and risk management obligations on crypto-asset service providers. The U.S. Securities and Exchange Commission and Commodity Futures Trading Commission require registered investment advisors and commodity pool operators using automated governance systems to maintain tamper-resistant audit trails. No existing DAO governance platform satisfies all of these requirements simultaneously with hardware-attested, independently verifiable evidence.

Existing zero-knowledge proof governance systems present a critical vulnerability: they manage cryptographic keys in software-accessible memory. An adversary can copy key material before the destruction step completes and use the copied key to generate a compliant-state proof after a threshold violation has already been detected. This class of attack cannot be prevented in software-managed key systems. The present invention closes this gap through hardware-enforced key destruction inside the TEE at the silicon level, where no process at any privilege level—including the enclave operator—can access or recover the key once it is zeroed.

Prior TEE-based systems including Intel SGX price oracles, Secret Network, and Oasis Sapphire provide enclave isolation for individual computations but fail in four critical ways. They provide no atomic risk-state transitions gating zero-knowledge proof generation on post-transition session keys. They provide no hardware-level proposal gating that a majority vote cannot override. They provide no multi-TEE quorum verification, meaning a single compromised enclave can authorize non-compliant actions. And they provide no simultaneous multi-jurisdictional regulatory evidence from a single computation. The combination of all these capabilities has not been taught or suggested by any prior art reference or obvious combination thereof.

Technical Improvement Under 35 U.S.C. § 101. The present invention improves the functioning of distributed ledger governance computer systems by introducing silicon-level enforcement mechanisms—atomic key destruction, hardware monotonic counters, multi-TEE quorum agreement, on-chain attestation registries, and post-quantum signature verification—that are architecturally impossible to achieve through software modifications alone. The technological problem is privileged tampering, rollback, and voting-power override in distributed governance systems. The technological solution is hardware-enforced irreversibility via TEE-specific mechanisms that no software implementation can replicate. As clarified in the August 2025 Kim Memorandum and December 2025 Desjardins guidance, limitations involving hardware-isolated execution and cryptographic irreversibility cannot practically be performed in the human mind and integrate any alleged abstract idea into a practical application, satisfying patent-eligibility criteria under Enfish and related authority.

Five new architecture elements introduced by the present invention do not appear in combination in any prior art. First, a Multi-TEE Quorum Verification Layer requires at least three independent TEE instances to agree on a risk result before any execution authorization is issued. Second, an On-Chain Attestation Registry publishes approved enclave measurements to a blockchain smart contract queried by governance contracts before accepting any execution token, preventing counterfeit governance engines from interacting with DAO infrastructure. Third, a Regulatory Verification Network enables regulators and auditors to run independent validation nodes that verify TEE attestations, monotonic counter values, and ledger commitments autonomously. Fourth, a Post-Quantum Attestation Layer applies NIST-standardized CRYSTALS-Dilithium, Falcon, or SPHINCS+signatures and CRYSTALS-Kyber key encapsulation to the full attestation and key management pipeline. Fifth, Automated Treasury Safeguards—hardware-enforced treasury freezes, graduated circuit-breaker withdrawal limits, and pre-emptive insurance pool funding triggers—activate concurrently with risk-state transitions, enforced by the same post-transition session key gating that blocks non-compliant proposal execution.

### SUMMARY OF THE INVENTION

The present invention provides a TEE-attested decentralized governance and compliance engine for regulated financial and tokenized asset networks. The engine enforces compliance through hardware-anchored proposal gating, multi-TEE quorum verification, an on-chain attestation registry, a regulatory verification network, automated treasury safeguards, post-quantum attestation and key derivation, AI-driven risk assessment inside enclave-protected memory, atomic risk-state transitions, quantum-resistant provenance ledgers, and zero-knowledge proof evidence formatted simultaneously for SEC, CFTC, MiCA, Basel IV, FCA, and FSB regulatory frameworks.

Why This Is Patent-Eligible. The invention improves the functioning of distributed ledger governance computer systems by introducing silicon-level enforcement mechanisms that are architecturally impossible to achieve in software alone. The five new architecture elements—Multi-TEE Quorum Verification Layer, On-Chain Attestation Registry, Regulatory Verification Network, Post-Quantum Attestation Layer, and Automated Treasury Safeguards—each reinforce the technical improvement argument while closing the most significant design-around risks in the prior art. These are concrete improvements to how distributed governance computers function, arising from the physical properties of silicon-level hardware isolation, not abstract ideas implemented in software.

The technical effect of the invention arises from all components working together. Hardware attestation makes zero-knowledge proof evidence non-forgeable. Multi-TEE quorum eliminates single-enclave compromise risk. The on-chain attestation registry prevents counterfeit governance engine deployment. The regulatory verification network transforms self-certification into independent verification. Post-quantum signatures protect the entire evidence chain across multi-decade retention horizons. Proposal gating makes compliance non-bypassable regardless of voting outcomes. Automated treasury safeguards extend hardware enforcement from governance decisions to asset protection. No prior art teaches or suggests this combination.

In a first aspect, the invention provides a hardware-anchored governance system comprising: TEE-resident processors with hardware root-of-trust binding; a Multi-TEE Quorum Verification Layer; an On-Chain Attestation Registry; a Regulatory Verification Network; a Proposal Gating Enforcer; an Evaluation-State Attestation Machine executing atomic four-step risk-state transitions; Automated Treasury Safeguards; a Post-Quantum Attestation Layer; an append-only quantum-resistant provenance ledger; and a Regulatory Verification Engine generating simultaneous multi-jurisdictional ZKP compliance evidence. In a second aspect, the invention provides a corresponding method. In a third aspect, it provides one or more non-transitory computer-readable media storing the instructions that, when executed within a TEE, perform those operations.

### DEFINITIONS

As used herein, the following ten terms are defined in alphabetical order. A plain-language explanation follows each definition to assist non-specialist readers; these explanations do not limit the scope of the claims.
1. “Append-Only Provenance Ledger” means an immutable hash-chained record residing in enclave-protected memory that uses SHA3-256 for individual entry hashing and SHA3-512 for Merkle root computation, recording all governance events with each entry cryptographically linked to the previous one in a manner that makes any alteration immediately detectable, with post-quantum signatures applied to Merkle root exports to ensure long-horizon regulatory retention viability.
   Plain language: An unforgeable chronological record of everything the governance engine did. Altering any single entry breaks the hash chain, making tampering immediately visible. Post-quantum signatures mean the records remain verifiable even against future quantum computers.
2. “Automated Treasury Safeguards” means hardware-enforced financial protection mechanisms activated concurrently with risk-state transitions, comprising automatic treasury asset freezes that prevent withdrawal authorization token generation when systemic risk thresholds are breached, graduated circuit-breaker withdrawal limits computed using blinded comparison operations proportional to risk threshold proximity, and pre-emptive insurance pool funding triggers authenticated with warning-state session keys, all enforced through post-transition session key gating inside the TEE independently of any governance vote or administrative action.
Plain language: The system does not just block bad proposals—it also automatically protects the treasury when risk levels become dangerous. These protections are hardware rules, not governance policy rules. A 99% majority vote cannot override them, because the key required to generate any withdrawal authorization physically does not exist after a threshold is breached.
3. “Evaluation-State Attestation Machine” means a state machine executing inside the TEE that transitions atomically from a compliant baseline state to a risk-degraded state upon detection of a threshold violation confirmed by quorum agreement, incorporating a risk-state-transition record into the hardware-signed attestation report user-data field and triggering forced re-keying, hardware monotonic counter increment, and IOMMU-enforced network isolation, creating cryptographically irreversible evidence of the compliance-state change that cannot be undone without complete TEE reinitialization.
   Plain language: Once the machine transitions to the risk-degraded state, it cannot go back without a full system restart. This makes it physically impossible to cover up that a violation occurred—not just against the rules, but architecturally impossible.
4. “Hardware Monotonic Counter” means a silicon-level counter bound to the chip hardware that can only increment and never decrement, incremented during risk-state transitions across all quorum-participating TEE instances simultaneously, providing tamper-resistant temporal ordering of governance events that prevents rollback and replay attacks at any software privilege level, including blockchain validators, relayer nodes, and hypervisors.
   Plain language: A counter embedded in the chip that only goes up. No software—including blockchain validators and cloud hypervisors—can roll it back or replay governance events out of sequence. Cross-instance verification means even a compromised single instance cannot forge a false counter value without the quorum detecting the discrepancy.
5. “Multi-TEE Quorum Verification Layer” means a mechanism in which at least three independent TEE instances, potentially spanning different hardware vendors or cloud providers, each independently compute the risk assessment result for a governance proposal and cross-verify enclave measurements, hardware monotonic counter values, and risk output hashes, with execution authorization generated only upon cryptographic quorum agreement across a threshold number of participating instances having produced identical risk outputs under verified, unmodified enclave measurements.
   Plain language: Instead of trusting a single chip vault, the system requires at least three independent vaults to reach the same risk conclusion before anything proceeds. If one vault is compromised—by hardware fault, side-channel attack, or vendor infiltration—the quorum fails and no authorization is issued.
6. “On-Chain Attestation Registry” means a smart contract deployed on at least one blockchain network that stores approved static enclave measurements for the governance engine, queried by governance smart contracts before accepting execution authorization tokens, wherein tokens generated by engines whose enclave measurements do not match the approved measurement are structurally rejected, and wherein measurement updates require TEE-attested multi-signature quorum authorization.
   Plain language: The blockchain keeps a public list of which chip fingerprints are approved to run the governance engine. A counterfeit or modified engine has a different fingerprint and is rejected automatically—even if it can generate valid-looking proofs—because the blockchain itself refuses its authorization tokens.
7. “Post-Quantum Attestation Layer” means a subsystem applying post-quantum cryptographic signature algorithms—including CRYSTALS-Dilithium, Falcon, or SPHINCS+, each a NIST Post-Quantum Cryptography standard—to attestation report signing and verification, and applying CRYSTALS-Kyber key encapsulation to inter-TEE communications within the quorum verification layer, providing cryptographic security against quantum computing attacks across the multi-decade retention periods required by SEC Rule 17a-4, CFTC Regulation 1.31, and MiCA governance documentation obligations.
   Plain language: Today's standard cryptographic signatures can eventually be broken by quantum computers. These NIST-standardized algorithms remain secure even against quantum attacks, keeping compliance evidence valid for the decades-long retention periods that financial regulators require.
8. “Proposal Gating Enforcer” means a TEE-resident module that produces on-chain execution authorization tokens exclusively from session keys bound to compliant-state attestations and quorum agreement confirmations, wherein each token carries attestation signatures of all quorum-participating instances and the On-Chain Attestation Registry measurement hash, and is computationally infeasible to generate without both quorum agreement and possession of a post-transition session key bound to a compliant-state attestation.
   Plain language: The authorization to execute a proposal can only be generated from a key that exists only while the system is in a compliant state and quorum has been reached. Once the baseline key is destroyed, generating an authorization for a non-compliant proposal is physically impossible—not just against the rules.
9. “Regulatory Verification Engine” means the subsystem that assembles compliance evidence packages combining hardware-signed attestation reports with post-quantum signatures, provenance ledger commitments, quorum agreement confirmations, and zero-knowledge proof outputs, formatted simultaneously for multiple regulatory portals via jurisdiction-specific adaptation modules for SEC, CFTC, MiCA, Basel IV, FCA, and FSB frameworks, with evidence package export structurally gated on four conditions: hardware-signed attestation verification, cryptographic quorum agreement confirmation, On-Chain Attestation Registry measurement verification, and Regulatory Verification Network node validation receipt.
   Plain language: The compliance packaging system takes all hardware-generated evidence and formats it for six different regulatory agencies simultaneously—from a single computation. Evidence cannot be exported until independent regulators running their own validation nodes have confirmed receipt and independent validation.
10. “Regulatory Verification Network” means a distributed network of independent verification nodes operated by regulators, designated auditors, or institutional counterparties that autonomously validate TEE attestation reports by checking enclave measurements against the On-Chain Attestation Registry, verify hardware monotonic counter value sequences for temporal consistency, and independently confirm provenance ledger Merkle commitment chains, making compliance evidence verifiable by third parties entirely separate from the governed system.
   Plain language: Regulators run their own validation software and check the evidence themselves—the governance engine cannot influence or manipulate their process. This transforms compliance from self-certification into independent verification, the most significant structural improvement over every prior compliance evidence system in regulated financial markets.

### BRIEF DESCRIPTION OF THE DRAWINGS

The accompanying drawings, incorporated in and constituting a part of this specification, illustrate embodiments of the invention and together with the description explain its principles. The drawings comprise five figures, each containing five sub-figures, for a total of thirty drawings.

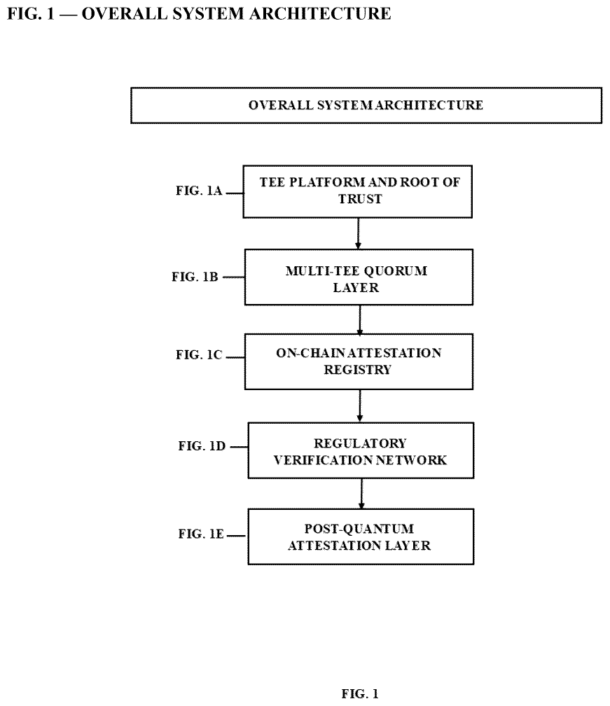

### FIG. 1—Overall System Architecture

FIG. 1 is a block diagram illustrating the top-level architecture of the Hardware-Anchored DAO Governance Engine, showing all major components and their relationships. The five new architecture elements—Multi-TEE Quorum Verification Layer, On-Chain Attestation Registry, Regulatory Verification Network, Post-Quantum Attestation Layer, and Automated Treasury Safeguards—are each shown as distinct components with labeled interconnections. Reference numerals used throughout designate corresponding elements consistently across all figures.

### FIG. 1A—Tee Platform and Root of Trust

FIG. 1A is a schematic diagram showing the TEE-resident governance platform initializing within enclave-protected memory pages on one or more processors, with the static enclave measurement established as a cryptographic hash of the enclave code and data signed by the hardware root-of-trust element.

Provider-specific measurement fields are shown for each supported environment: the MRENCLAVE value in Intel SGX, the Versioned Chip Endorsement Key signature in AMD SEV-SNP, the TDREPORT structure in Intel TDX, the NSM attestation document in AWS Nitro Enclaves, and the TPM Platform Configuration Register binding in ARM TrustZone. The hardware isolation boundary is depicted, showing the enclave boundary that prevents blockchain node software, relayer infrastructure, hypervisors, and cloud provider management planes from accessing enclave-protected memory at any privilege level.

### FIG. 1B—Multi-Tee Quorum Layer

FIG. 1B is a schematic diagram illustrating at least three independent TEE instances—drawn from different hardware vendors or cloud providers—each independently computing the risk assessment result for an incoming governance proposal before any execution pathway is triggered.

The cross-verification process is shown, in which each instance distributes its attestation report—including its enclave measurement, hardware monotonic counter value, and risk output hash—to all other participating instances for independent verification before quorum agreement is established.

The structural dependency of execution authorization generation on cryptographic quorum agreement is depicted, showing that a single compromised TEE instance producing a divergent risk output is detected by the cross-verification process and excluded from quorum, preventing any single compromise from authorizing non-compliant proposal execution.

### FIG. 1C—On-Chain Attestation Registry

FIG. 1C is a schematic diagram of the On-Chain Attestation Registry smart contract deployed on a blockchain network, showing approved static enclave measurements stored in the registry and the query interface through which governance smart contracts verify engine identity before accepting execution authorization tokens.

The TEE-attested multi-signature authorization process required for measurement updates is illustrated, showing that modification of the approved measurement list requires cryptographic quorum agreement from participating TEE instances, preventing unauthorized registry updates even by the DAO operator.

The rejection pathway for counterfeit governance engines is depicted, showing that execution authorization tokens generated by engines with non-matching enclave measurements are structurally rejected by governance contracts at the smart contract level, without requiring external policy enforcement or human intervention.

### FIG. 1D—Regulatory Verification Network

FIG. 1D is a schematic diagram of the Regulatory Verification Network showing independent verification nodes operated by regulators, designated auditors, and institutional counterparties, each receiving TEE attestation reports, hardware monotonic counter values, and provenance ledger Merkle commitments from the governance engine.

Each node's independent validation pipeline is shown: querying the On-Chain Attestation Registry to verify the enclave measurement, checking hardware monotonic counter sequences for temporal consistency, and verifying provenance ledger Merkle commitment chains—all independently of the governed system.

The compliance evidence export gating mechanism is depicted, showing that compliance evidence packages cannot be finalized and dispatched to regulatory portals until Regulatory Verification Network node validation receipts have been received, transforming compliance from self-certification into independently verifiable cryptographic fact.

### FIG. 1E—Post-Quantum Attestation Layer

FIG. 1E is a schematic diagram of the Post-Quantum Attestation Layer showing CRYSTALS-Dilithium signatures applied to attestation report signing and verification, providing security against Shor's algorithm attacks on classical signature schemes for the multi-decade retention periods required by financial regulators.

CRYSTALS-Kyber key encapsulation applied to inter-TEE communications within the Multi-TEE Quorum Verification Layer is illustrated, along with Falcon and SPHINCS+as alternative NIST Post-Quantum Cryptography standard algorithms available in respective embodiments.

The post-quantum session key derivation pipeline is shown, illustrating how post-transition session keys are derived from risk-degraded-state attestations using post-quantum key derivation, ensuring the cryptographic irreversibility of forced re-keying remains secure against quantum computing adversaries.

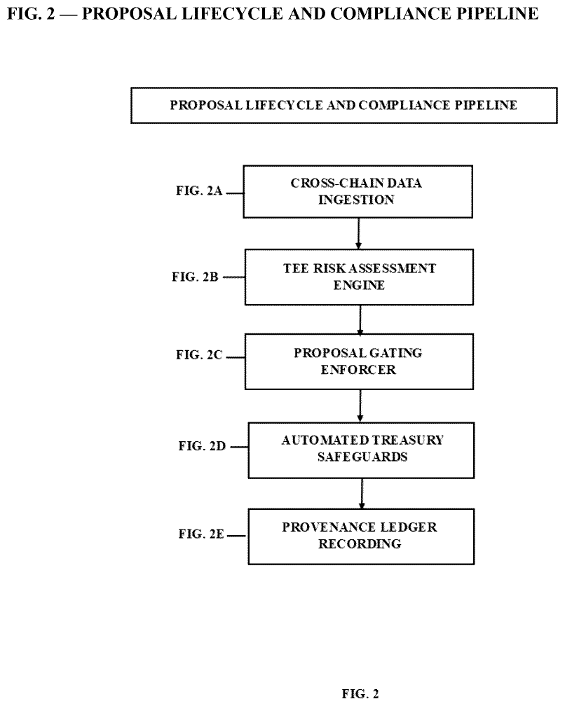

### FIG. 2—Proposal Lifecycle and Compliance Pipeline

FIG. 2 is a block diagram illustrating the end-to-end DAO proposal lifecycle from initial submission through risk assessment, quorum agreement, gating decision, state transition or execution authorization, treasury safeguard evaluation, ledger recording, and regulatory evidence generation. The diagram shows the complete governance pipeline as a linear flow with decision branches at the compliance gating step. All components executing within enclave-protected memory are shown within a shaded enclave boundary.

### FIG. 2A—Cross-Chain Data Ingestion

FIG. 2A is a schematic diagram showing on-chain proposal content arriving via attested smart contract interfaces that verify TEE identity before transmitting proposal data, and off-chain treasury position data arriving from institutional custodians via attested APIs with source identity cryptographically bound to each ingestion record.

Cross-Chain Interoperability Adapters executing within enclave-protected memory are illustrated, normalizing governance and treasury exposure data from Ethereum mainnet, Ethereum Layer 2 rollups, Avalanche, Polygon, Solana, Hyperledger Fabric, and R3 Corda into a unified attestation-verified risk input schema.

The attestation verification step applied to all incoming data before it is admitted to enclave-protected memory is depicted, showing that malformed, unattested, or source-unverified data is structurally rejected before reaching the risk assessment engine.

### FIG. 2B—Tee Risk Assessment Engine

FIG. 2B is a schematic diagram of the TEE-resident AI risk assessment engine evaluating each governance proposal against sealed compliance thresholds across four dimensions: liquidity impact on Basel IV LCR and NSFR ratios; systemic contagion risk across cross-protocol exposure pathways; capital adequacy impact against Basel IV Pillar I; and regulatory compliance status against MiCA Article 45, SEC Rule 206(4)-2, and CFTC position limit thresholds.

Compliance thresholds sealed in enclave-protected memory at initialization are shown as inaccessible to all external processes, and constant-time comparison operations used for all evaluations are depicted with annotations explaining their role in preventing timing side-channel attacks.

The quorum cross-verification step following individual instance risk computation is illustrated, showing each instance distributing its risk output hash to all other participating instances for cross-verification before quorum agreement is established and either the compliant or non-compliant pathway is triggered.

### FIG. 2C—Proposal Gating Enforcer

FIG. 2C is a schematic diagram of the Proposal Gating Enforcer showing the compliant proposal pathway, in which an execution authorization token is derived from the compliant-state session key carrying attestation signatures of all quorum-participating instances and the On-Chain Attestation Registry measurement hash, enabling governance smart contracts to verify both quorum agreement and registry-approved engine identity in a single verification operation.

The non-compliant proposal pathway is shown, in which threshold violation detection confirmed by quorum triggers the Evaluation-State Attestation Machine rather than token generation, and the subsequent destruction of the baseline session key makes execution authorization generation computationally infeasible regardless of the governance vote outcome.

The On-Chain Attestation Registry verification step performed by the receiving governance smart contract is depicted, showing how the token's embedded registry measurement hash is checked against the registry on the target blockchain before the contract processes the authorization, extending hardware-enforced compliance to the on-chain execution layer.

### FIG. 2D—Automated Treasury Safeguards

FIG. 2D is a schematic diagram of the Automated Treasury Safeguard module activating concurrently with the Evaluation-State Attestation Machine upon threshold violation, showing the automatic treasury freeze that withholds all withdrawal authorization tokens until quorum re-evaluation confirms threshold restoration.

The graduated circuit-breaker withdrawal limit mechanism is shown, illustrating maximum withdrawal amounts reduced proportionally to risk score proximity to sealed threshold boundaries, computed using blinded comparison operations, with time-locked post-transition authorization tokens enforcing the reduced limits.

The pre-emptive insurance pool funding trigger is depicted, showing warning-state session key derivation from an attestation distinct from both compliant-state and risk-degraded-state attestations, and the authenticated on-chain insurance pool funding call generated when risk scores exceed the configurable early-warning level before hard enforcement activates.

### FIG. 2E—Provenance Ledger Recording

FIG. 2E is a schematic diagram of the append-only provenance ledger recording all governance events—including proposal ingestion, risk assessment outputs, quorum confirmations, threshold violations, state transitions, treasury safeguard activations, and execution authorizations—with each entry linked to the previous by a SHA3-256 hash forming the quantum-resistant chain.

Hardware monotonic counter values and attestation report user-data field bindings incorporated into each ledger entry are shown, along with post-quantum CRYSTALS-Dilithium or SPHINCS+signatures applied to Merkle roots computed with SHA3-512, providing cryptographic security for multi-decade regulatory recordkeeping.

Regulatory Verification Network node confirmation receipts recorded as additional fields in each governance event entry are depicted, showing how independent third-party validation is embedded in the provenance record, creating an auditable chain of custody from silicon-level execution through regulatory submission.

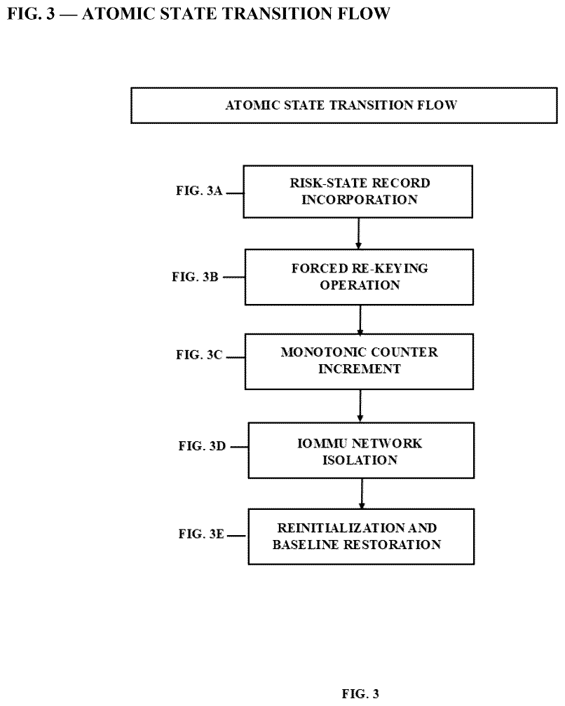

### FIG. 3—Atomic State Transition Flow

FIG. 3 is a block diagram illustrating the complete atomic four-step risk-state transition sequence executed by the Evaluation-State Attestation Machine upon detection of a threshold violation confirmed by quorum agreement. The diagram shows all four steps executing atomically with no partial intermediate states, with cross-references to sub-figures FIG. 3A through FIG. 3E for detailed depictions of each step and the reinitialization path.

### FIG. 3A—Risk-State Record Incorporation

FIG. 3A is a schematic diagram showing the risk-state-transition record—comprising a transition flag, high-resolution timestamp, identifier of the specific regulatory threshold breached, and cumulative counter value—written to enclave-protected memory and incorporated into the attestation report user-data field across all quorum-participating TEE instances simultaneously.

Provider-specific user-data field mappings are illustrated: the REPORTDATA field in Intel SGX, the report_data field in AMD SEV-SNP, the user_data field of the TDREPORT in Intel TDX, and the NSM user data field in AWS Nitro Enclaves, showing how the same risk-state-transition record is bound to each provider's hardware-signed attestation format.

The resulting attestation report as independently verifiable evidence of the compliance violation is depicted, showing that the hardware signature binding the risk-state-transition record to the enclave measurement and monotonic counter makes the record unforgeable without physically compromising the processor chip.

### FIG. 3B—Forced Re-Keying Operation

FIG. 3B is a schematic diagram of the forced re-keying operation showing the baseline session key being atomically zeroed from enclave-protected memory—permanently unrecoverable by any process at any privilege level—while simultaneously a new post-transition session key is derived from the risk-degraded-state attestation using post-quantum CRYSTALS-Kyber key derivation within the TEE.

The structural impossibility of compliant-state authorization token generation and ZKP proof instantiation after baseline key destruction is illustrated, showing that the post-transition key derived from the degraded-state attestation is cryptographically distinct from the compliant-state key and cannot substitute for it in token generation or proof construction circuits.

The contrast with software-only key destruction is depicted, showing how software key stores reside in memory accessible to processes capable of copying key material before zeroing completes, and why silicon-level enclave isolation eliminates this vulnerability by making the key physically inaccessible to all external processes throughout its lifecycle.

### FIG. 3C—Monotonic Counter Increment

FIG. 3C is a schematic diagram illustrating the hardware monotonic counter increment across all quorum-participating TEE instances, showing the silicon-level counter advancing in each instance and the cross-instance counter verification step confirming all instances have incremented to the expected next value.

The tamper-resistant temporal ordering property is depicted, showing how counter values recorded in provenance ledger entries and attestation reports establish an unforgeable governance event sequence that cannot be reordered or replayed by any software process at any privilege level.

The rollback prevention mechanism is illustrated by showing that attestation reports or ledger entries presenting monotonic counter values lower than the current verified value are detected and rejected by Regulatory Verification Network nodes during independent validation, providing a second independent layer of event sequence integrity.

### FIG. 3D—IOMMU Network Isolation

FIG. 3D is a schematic diagram showing IOMMU-enforced network isolation activating at the hardware level across all quorum-participating TEE instances during the state transition, preventing data exfiltration from the enclave by adversaries who may have compromised relayer nodes or governance infrastructure during the security-critical transition window.

The hardware-level independence of IOMMU isolation from software-layer access controls is depicted, showing the isolation operating below the operating system and hypervisor layers, unable to be lifted by any software process regardless of privilege level.

The isolation maintenance mechanism is illustrated, showing the quorum re-evaluation process required to confirm threshold restoration across all participating instances before IOMMU isolation is released, ensuring re-evaluation occurs under the same hardware-enforced conditions as the initial risk assessment that triggered the transition.

### FIG. 3E—Reinitialization and Baseline Restoration

FIG. 3E is a schematic diagram illustrating the complete TEE reinitialization process required for reversion to the compliant baseline state, showing all session keys destroyed across all quorum-participating instances, attestation state reset to initialization conditions, and new static enclave measurements established.

The On-Chain Attestation Registry update process following reinitialization is shown, depicting new enclave measurements submitted through a TEE-attested multi-signature authorization transaction requiring quorum agreement from reinitializing instances before updated measurements are accepted.

The contrast between reinitialization-required restoration and software-only compliance systems is depicted, illustrating why the reinitialization path—which requires destroying all state and restarting from scratch—makes the risk-degraded state cryptographically irreversible in a way that software-based state variable modification cannot replicate.

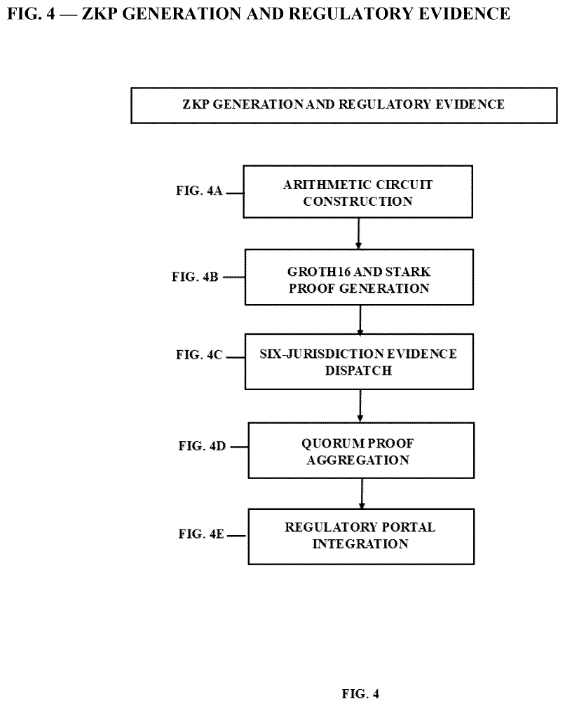

### FIG. 4—ZKP Generation and Regulatory Evidence

FIG. 4 is a block diagram illustrating the zero-knowledge proof generator, the Regulatory Verification Engine, and the multi-jurisdictional evidence pack dispatch architecture, showing how a single proof computation produces simultaneously formatted compliance evidence for six regulatory frameworks. The diagram shows the complete evidence generation pipeline from arithmetic circuit construction through regulatory portal submission, with all gating conditions depicted as decision points.

### FIG. 4A—Arithmetic Circuit Construction

FIG. 4A is a schematic diagram of the arithmetic circuit construction process encoding four categories of public inputs: SHA-3 Merkle commitments of the provenance ledger, attestation report user-data fields incorporating risk-state-transition records, hardware monotonic counter values, and quorum participation confirmations from all agreeing TEE instances.

The private input isolation architecture is shown, depicting risk model parameters, treasury positions, voting weight distributions, and governance token holder identities as private circuit inputs never revealed in proof outputs, enabling regulators to verify compliance without accessing commercially sensitive or privacy-protected information.

The structural dependency of proof instantiation on the post-transition session key is illustrated, showing the cryptographic pathway that makes generation of a valid proof prior to completion of the atomic four-step transition computationally infeasible, closing the pre-transition compliance attestation vulnerability present in all prior software-managed ZKP governance systems.

### FIG. 4B—Groth16 and Stark Proof Generation

FIG. 4B is a schematic diagram comparing Groth16 and STARK proof constructions available in respective embodiments, showing Groth16 producing constant-size proofs verifiable in sub-millisecond timeframes suited for real-time integration with SEC EDGAR, CFTC reporting systems, and ESMA MiCA supervisory portals.

The STARK-based construction is illustrated as an alternative providing full post-quantum resistance through exclusive reliance on SHA-3 hash function collision hardness, requiring no trusted setup ceremony, suited for long-horizon governance deployments where both post-quantum security and ceremony-free operation are requirements.

Per-jurisdiction configurability of the proof construction is depicted, showing the selection mechanism by which the Regulatory Verification Engine chooses the appropriate construction for each target regulatory portal based on that portal's verification infrastructure, enabling simultaneous multi-jurisdiction proof submission using each regulator's preferred cryptographic system.

### FIG. 4C—Six-Jurisdiction Evidence Dispatch

FIG. 4C is a schematic diagram of the Regulatory Verification Engine's six jurisdiction-specific adaptation modules operating simultaneously from a single ZKP proof set, showing the SEC adapter for Form PF, Form ADV, and Schedule D; the CFTC adapter for Regulation 4.22 and NFA compliance filing; and the MiCA adapter for ESMA Articles 68 through 76 governance documentation.

The Basel IV adapter for EBA and BCBS Pillar III disclosure reporting, the FCA adapter for UK Financial Services and Markets Act 2023 cryptoasset governance requirements, and the FSB adapter for globally systemically important institution cross-border reporting are illustrated, with all six operating from the same underlying proof computation.

The four-condition evidence export gating mechanism is depicted, showing that no jurisdiction-specific package is released until hardware-signed attestation verification, quorum agreement confirmation, On-Chain Attestation Registry measurement verification, and Regulatory Verification Network node validation receipt are all simultaneously satisfied.

### FIG. 4D—Quorum Proof Aggregation

FIG. 4D is a schematic diagram illustrating the aggregation of attestation signatures from all quorum-participating TEE instances into a unified quorum proof structure included as a public ZKP circuit input, enabling any verifying party to confirm that the approved combination of TEE instances reached agreement on the underlying risk assessment.

The cross-provider attestation normalization layer is depicted, showing provider-specific formats from Intel SGX, AMD SEV-SNP, Intel TDX, ARM TrustZone, and AWS Nitro Enclaves translated to a common internal representation by the Regulatory Verification Engine's cross-provider adaptation layer for consistent quorum proof structures across heterogeneous deployments.

The verification of quorum proof structures by Regulatory Verification Network nodes is illustrated, showing each node independently verifying participating instance enclave measurements against the On-Chain Attestation Registry, monotonic counter consistency, and cryptographic agreement among all participants'risk output hashes before issuing a validation receipt.

### FIG. 4E—Regulatory Portal Integration

FIG. 4E is a schematic diagram of the integration interfaces between the Regulatory Verification Engine and target regulatory portals, showing attested submission channels transmitting completed evidence packages to SEC EDGAR, CFTC reporting infrastructure, ESMA MiCA supervisory portals, national competent authority Basel IV reporting systems, FCA regulatory portals, and FSB cross-border reporting frameworks.

The Regulatory Verification Network node validation receipt embedded in each submission package is shown, depicting the node identity, validation timestamp and sequence number, and cryptographic confirmation signature as fields included in each package, enabling regulators to cross-reference submissions against their own network node records.

Post-quantum signature application to all evidence package exports is illustrated, showing CRYSTALS-Dilithium signatures applied to each aggregated compliance evidence package before transmission, ensuring packages received by regulatory portals can be verified as authentic and unmodified across the multi-decade retention periods applicable to regulated financial institution governance records.

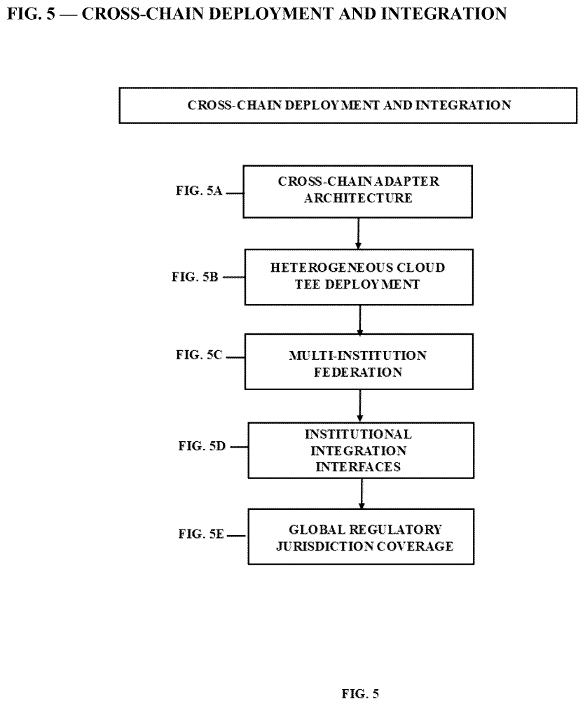

### FIG. 5—Cross-Chain Deployment and Integration

FIG. 5 is a block diagram illustrating the cross-chain interoperability architecture, heterogeneous cloud TEE deployment across multiple providers, and global DAO governance workflow integration according to an embodiment of the invention. The diagram shows the complete deployment topology from on-premises and cloud TEE instances through cross-chain bridge adapters to on-chain governance contracts across multiple blockchain networks.

### FIG. 5A—Cross-Chain Adapter Architecture

FIG. 5A is a schematic diagram of Cross-Chain Interoperability Adapters executing within enclave-protected memory, collecting and normalizing governance and treasury exposure data from Ethereum mainnet, Ethereum Layer 2 rollup networks, Avalanche, Polygon, and Solana for DeFi protocol governance, and from Hyperledger Fabric and R3 Corda for permissioned enterprise distributed ledger deployments.

The attestation-binding of each cross-chain data contribution is shown, depicting how the source blockchain network, the cross-chain bridge or messaging protocol, and the attestation verification status of the data source are cryptographically bound to each normalized data entry and recorded in the provenance ledger, enabling end-to-end provenance for governance decisions incorporating multi-chain data.

The attested bridge interface architecture for execution authorization token delivery is illustrated, showing how tokens are transmitted to target governance contracts via interfaces that verify TEE identity and confirm the enclave measurement against the On-Chain Attestation Registry on each target blockchain before the governance contract processes the token.

### FIG. 5B—Heterogeneous Cloud Tee Deployment

FIG. 5B is a schematic diagram illustrating heterogeneous cloud TEE deployment across AWS Nitro Enclaves using Nitro Hypervisor isolation and NSM attestation, Azure Confidential Virtual Machines with AMD SEV-SNP using VCEK-signed attestation reports, Google Cloud Confidential Virtual Machines with Intel TDX using the TDREPORT structure, and ARM TrustZone on institutional edge infrastructure for on-premises deployment.

Risk-state-transition record mapping to provider-specific attestation user-data fields is shown for each environment—NSM user data for AWS, report_data for SEV-SNP, user_data of the TDREPORT for TDX, and PCR bindings for TrustZone—with the cross-provider normalization layer translating each format to a common representation for quorum cross-verification.

Security property consistency across heterogeneous environments is depicted, showing that cryptographic irreversibility, temporal ordering, non-repudiation, privacy-preserving verifiability, and multi-layer hardware defense properties are maintained identically across all supported cloud TEE environments without requiring modification to core attestation and re-keying logic.

### FIG. 5C—Multi-Institution Federation

FIG. 5C is a schematic diagram showing multi-institution DAO governance federation in which participating institutions each operate one or more TEE instances contributing to the Multi-TEE Quorum Verification Layer, with each institution's instances publishing static enclave measurements to the On-Chain Attestation Registry and receiving registry-approved measurement lists for cross-verification against other institutions'instances.

The unified cryptographic governance state enforcement across a multi-chain DAO is depicted, showing compliance evidence for proposals spanning multiple blockchain networks cryptographically bound to a common attestation-anchored governance state verified by quorum agreement across all participating instances from all member institutions.

Cross-institution Regulatory Verification Network participation is illustrated, showing each member institution's regulatory counterparties operating their own validation nodes to independently validate governance events relevant to their regulatory relationship, with a common validation receipt format enabling aggregation of multi-institution receipts into unified compliance evidence submissions.

### FIG. 5D—Institutional Integration Interfaces

FIG. 5D is a schematic diagram of integration interfaces between the governance engine and institutional financial infrastructure, showing attested REST and FIX protocol adapters for institutional treasury management system ingestion, attested custodian API interfaces for qualified custodian asset management under SEC Rule 206(4)-2, and the white-label deployment architecture for regulated crypto-asset service providers under MiCA licensing.

The white-label deployment workflow is illustrated, showing governance engine instructions distributed on non-transitory computer-readable media installed within a TEE-capable environment, publishing its static enclave measurement to the On-Chain Attestation Registry through an attested provisioning channel and initializing with sealed compliance thresholds provided through an attested configuration channel.

The SaaS deployment model for institutional DeFi compliance service providers is shown, depicting multiple DAO clients each processed through dedicated TEE instances registered under the service provider's approved measurement set in the On-Chain Attestation Registry, with each client's Regulatory Verification Network receiving independent validation of their specific governance events.

### FIG. 5E—Global Regulatory Jurisdiction Coverage

FIG. 5E is a schematic diagram illustrating global regulatory jurisdiction coverage of the Regulatory Verification Engine, showing the geographic scope of each jurisdiction-specific adaptation module: SEC and CFTC adapters covering U.S.-domiciled DAOs and registered investment advisors; the MiCA adapter covering EU crypto-asset service providers; the Basel IV adapter covering systemically important financial institutions in all Basel Committee member jurisdictions; the FCA adapter covering UK-regulated cryptoasset businesses; and the FSB adapter covering globally systemically important institutions.

The single-computation multi-jurisdiction evidence generation pathway is depicted, showing how a single DAO governance proposal produces one ZKP proof set that simultaneously satisfies evidence requirements across all applicable regulatory jurisdictions without requiring separate governance computations, proof generations, or regulatory submissions per jurisdiction.

Regulatory Verification Network node assignment by jurisdiction is illustrated, showing nodes operated by or on behalf of the SEC, ESMA, the FCA, national competent authorities for Basel IV, and the FSB each receiving jurisdiction-specific formatted evidence packages, independently validating the underlying attestation, and issuing receipts embedded in the final compliance submissions to each regulatory portal.

### DETAILED DESCRIPTION OF THE INVENTION

The following description enables a person skilled in the art to make and use the invention. Plain-language notes in italics are provided at each major mechanism to assist non-specialist readers and do not limit the scope of the claims.

### I. System Architecture Overview

Referring to FIG. 1 and FIG. 1A, the Hardware-Anchored DAO Governance Engine, referred to herein as the Engine, comprises a TEE-resident governance platform executing within enclave-protected memory pages. During initialization, a static enclave measurement is established as a cryptographic hash of the enclave code and data, signed by the hardware root-of-trust element. The hardware root-of-trust element cannot be modified by any software at any privilege level, including blockchain node software, relayer infrastructure, hypervisors, and cloud provider management planes. This silicon-level isolation is the foundational property distinguishing the present invention from every prior DAO governance system, all of which execute security-critical governance logic in software memory accessible to sufficiently privileged adversaries.
Plain language: At startup, the chip takes a fingerprint of the entire governance software stack and signs it with a key embedded in the silicon. Any regulator, auditor, or counterparty can verify that exact, unmodified software is running before trusting any output. No amount of clever software can forge this fingerprint without physically modifying the chip.

Referring to FIG. 1B, the Multi-TEE Quorum Verification Layer requires at least three independent TEE instances—potentially spanning multiple hardware vendors and cloud providers—to each independently compute the risk assessment result for every governance proposal. Quorum agreement is established by cross-verifying each instance's attestation report, enclave measurement, hardware monotonic counter value, and risk output hash against the outputs of all other participating instances. Execution authorization is generated only when cryptographic quorum agreement is reached among a threshold number of instances having produced identical risk outputs under verified, unmodified enclave measurements.
Plain language: Three or more independent chip vaults must reach the same risk conclusion before anything proceeds. If one vault is compromised—by hardware fault, side-channel attack, or vendor-level infiltration—the quorum fails automatically and no authorization is issued.

Referring to FIG. 1C, the On-Chain Attestation Registry is a smart contract storing approved static enclave measurements. Every governance smart contract queries the registry before accepting an execution authorization token. A token from an engine with a non-matching measurement is structurally rejected at the smart contract level without requiring any external policy enforcement. Measurement updates require TEE-attested multi-signature quorum authorization, ensuring the registry itself cannot be compromised without attacking the hardware.
Plain language: The blockchain keeps a public list of approved chip fingerprints. A counterfeit or modified engine has a different fingerprint and is automatically rejected—even if it can generate valid-looking proofs—because the blockchain itself refuses its tokens.

Referring to FIG. 1D, the Regulatory Verification Network comprises independent nodes operated by regulators, auditors, or institutional counterparties. Each node independently queries the On-Chain Attestation Registry to verify the enclave measurement, checks hardware monotonic counter sequences for temporal consistency, and verifies provenance ledger Merkle commitment chains. Compliance evidence packages cannot be exported until Regulatory Verification Network node validation receipts have been received, making compliance independently verifiable rather than self-asserted.
Plain language: Regulators run their own validation software and check the evidence themselves. The Engine cannot influence or manipulate their verification process in any way. This transforms compliance from self-certification into independently verifiable cryptographic fact.

Referring to FIG. 1E, the Post-Quantum Attestation Layer applies CRYSTALS-Dilithium signatures to attestation report signing and verification, and CRYSTALS-Kyber key encapsulation to inter-TEE communications, providing cryptographic security against quantum computing attacks. In alternative embodiments, Falcon provides smaller signatures for high-throughput environments, and SPHINCS+provides security based exclusively on hash function collision resistance requiring no lattice assumptions.
Plain language: Today's standard signatures can eventually be broken by quantum computers. These NIST-standardized algorithms remain secure even against quantum attacks, keeping compliance evidence valid for the decades-long retention periods financial regulators require.

### II. Risk Assessment, Proposal Gating, and Quorum Execution

Referring to FIG. 2B, the TEE-resident AI risk assessment engine evaluates each governance proposal within enclave-protected memory using constant-time comparison operations throughout. The four dimensions assessed are: liquidity impact on Basel IV LCR and NSFR ratios; systemic contagion risk across cross-protocol and cross-chain exposure pathways; capital adequacy impact against Basel IV Pillar I thresholds; and regulatory compliance status against MiCA Article 45 reserve requirements, SEC Rule 206(4)-2 custody safeguards, and CFTC position limit thresholds. All risk model parameters and thresholds are sealed in enclave-protected memory at initialization, inaccessible to blockchain node operators, relayers, and governance token holders. Constant-time operations prevent timing side-channel attacks that could reveal threshold proximity to adversaries crafting proposals to approach compliance boundaries without triggering enforcement.

Referring to FIG. 2C, following quorum agreement, the Proposal Gating Enforcer produces an on-chain execution authorization token exclusively from the compliant-state session key. For compliant proposals, the token carries attestation signatures from all quorum-participating instances and the On-Chain Attestation Registry measurement hash, enabling governance smart contracts to verify both quorum agreement and registry-approved engine identity in a single verification. For non-compliant proposals, the Evaluation-State Attestation Machine executes the atomic four-step transition and no token can be generated—the baseline session key is destroyed and no process at any privilege level can recover it.
Plain language: The authorization to execute a proposal can only be generated from a key that exists only while the system is compliant and quorum has been reached. Once the baseline key is destroyed, generating an authorization for a non-compliant proposal is physically impossible—not just against the rules.

### III. Atomic Risk-State Transition

Referring to FIG. 3, upon detection of a threshold violation confirmed by quorum, the Evaluation-State Attestation Machine executes four steps atomically inside the TEE—all four complete together or none complete, with no exploitable partial intermediate states.
Step 1—Record: A risk-state-transition record—comprising a transition flag, high-resolution timestamp, identifier of the specific threshold breached, and cumulative counter value—is written to enclave memory and incorporated into the attestation report user-data field across all quorum-participating instances simultaneously, binding the violation to the hardware-signed attestation in a form independently verifiable by Regulatory Verification Network nodes. See FIG. 3A.
Step 2—Re-key: Forced re-keying simultaneously zeros the baseline session key from enclave memory—permanently unrecoverable by anyone, including the enclave operator—and derives a new post-transition session key from the risk-degraded-state attestation using post-quantum CRYSTALS-Kyber key derivation. This makes it physically impossible to generate a compliant-state authorization or proof after a violation is detected. See FIG. 3B.
Step 3—Count: The hardware monotonic counter increments across all participating instances—a silicon-level operation unreversible by any software process at any privilege level—providing tamper-resistant temporal ordering of governance events and preventing replay attacks. See FIG. 3C.
Step 4—Isolate: IOMMU-enforced network isolation activates at the hardware level across all participating instances, preventing data exfiltration independently of software-layer access controls, and is maintained until quorum re-evaluation confirms restoration of all compliance thresholds. See FIG. 3D.

Three independent mechanisms enforce cryptographic irreversibility. Baseline key destruction eliminates the material for compliant-state tokens and proofs at the silicon level. Binding the risk-state-transition record to hardware-signed attestation creates externally verifiable evidence that cannot be forged without physically compromising the processor chip. Hardware monotonic counter increment prevents event sequence rollback at any software privilege level. The Post-Quantum Attestation Layer ensures all three irreversibility properties persist against quantum computing adversaries.

### IV. ZKP Evidence Generation and Regulatory Dispatch

Referring to FIG. 4A, the ZKP generator produces constant-size proofs encoding four categories of public inputs: SHA-3 Merkle commitments of the provenance ledger; attestation user-data fields incorporating risk-state-transition records; hardware monotonic counter values; and quorum participation confirmations from all agreeing TEE instances. Private inputs—risk model parameters, treasury positions, voting weight distributions, and token holder identities—are never disclosed. Proof generation requires the post-transition session key as a structural precondition, making it computationally infeasible to generate a valid proof before the atomic transition is complete.
Plain language: The proof says the rules were followed without revealing what the rules are, what the treasury holds, or who voted. A regulator can fully verify compliance without seeing any sensitive model or investor data. A valid proof cannot exist before the atomic transition is complete.

Referring to FIG. 4C, the Regulatory Verification Engine simultaneously formats compliance evidence packages for six regulatory frameworks from a single ZKP proof. A SEC adapter handles Form PF, Form ADV, and Schedule D. A CFTC adapter covers Regulation 4.22 and NFA compliance. A MiCA adapter addresses ESMA Articles 68 through 76. A Basel IV adapter handles EBA and BCBS Pillar III disclosures. An FCA adapter covers UK Financial Services and Markets Act 2023. An FSB adapter handles globally systemically important institution cross-border reporting. Evidence package export is gated on four conditions simultaneously: hardware-signed attestation verification, quorum confirmation, On-Chain Attestation Registry measurement verification, and Regulatory Verification Network validation receipt.

### V. Automated Treasury Safeguards

Referring to FIG. 2D, the Automated Treasury Safeguard module activates concurrently with the Evaluation-State Attestation Machine when risk thresholds are breached. All three safeguard mechanisms are enforced through post-transition session key gating inside the TEE—a hardware-architectural property making them non-bypassable by governance votes or administrative action for the same reason non-compliant proposals cannot be authorized: the key required to circumvent them physically does not exist after a threshold is breached.
Plain language: The system does not just block bad proposals—it automatically protects the treasury when risk levels become dangerous. These are hardware rules. A 99% majority vote cannot override them.

An automatic treasury freeze withholds all withdrawal authorization tokens when systemic risk thresholds are breached, until quorum re-evaluation confirms restoration. Graduated circuit-breaker withdrawal limits reduce maximum withdrawal amounts proportionally to risk score proximity to threshold boundaries, computed using blinded comparison operations that do not reveal sealed threshold values, enforced through time-locked post-transition authorization token issuance. Pre-emptive insurance pool funding triggers activate when risk scores exceed a configurable early-warning level below the hard threshold, using a distinct warning-state session key to generate authenticated on-chain funding calls before hard enforcement activates.

### VI. Preferred Embodiment

The following sequence demonstrates complete operation across three Engine instances—one in AWS Nitro Enclaves, one in Azure Confidential VMs with AMD SEV-SNP, and one in Google Cloud Confidential VMs with Intel TDX—governing a DeFi lending DAO with $2.4 billion in cross-chain collateral subject to Basel IV liquidity requirements.
Step 1—Initialization: All three instances establish static enclave measurements and publish them to the On-Chain Attestation Registry on Ethereum mainnet through TEE-attested multi-signature authorization. Risk parameters, compliance thresholds, and post-quantum CRYSTALS-Dilithium and CRYSTALS-Kyber keys are loaded into enclave-sealed memory across all three instances. Regulatory Verification Network nodes operated by the relevant supervisory authorities are confirmed active.
Step 2—Data Ingestion: A governance proposal to reallocate thirty-five percent of stablecoin reserves into a seven-day redemption fund is submitted on-chain. Proposal content arrives via attested Ethereum JSON-RPC interfaces. Cross-chain exposure data from Avalanche and Polygon bridge protocols is normalized by Cross-Chain Interoperability Adapters inside all three TEE instances.
Step 3—Quorum Risk Assessment: All three instances independently determine the reallocation would reduce LCR from one hundred twenty-eight to eighty-nine percent, below the sealed one hundred percent Basel IV minimum. Quorum agreement is established by cross-verifying attestation reports, enclave measurements, and risk output hashes across all three instances.
Step 4—Atomic Transition and Treasury Protection: All three instances simultaneously execute the atomic four-step transition. The LCR violation record is incorporated into each instance's attestation user-data field. Baseline session keys are destroyed with CRYSTALS-Kyber post-transition key derivation. Hardware monotonic counters increment across all three instances. IOMMU isolation activates. Simultaneously, the treasury freeze activates and an insurance pool funding call is authenticated with the warning-state session key.
Step 5—Ledger Recording: SHA 3-256 hash-chained ledger entries are recorded across all three instances for all governance events. Merkle roots are computed with SHA3-512. CRYSTALS-Dilithium signatures are applied to Merkle root exports. Regulatory Verification Network nodes independently confirm and issue validation receipts for all ledger commitments.
Step 6—Regulatory Evidence Generation: Groth16 ZKP proofs encoding Merkle commitments, post-transition attestation fields, monotonic counter values, and quorum participation confirmations are generated. The Regulatory Verification Engine assembles evidence packs after all four gating conditions are satisfied. Jurisdiction-specific adapters simultaneously format Basel IV supervisory reporting and MiCA governance documentation packages from one computation, one proof, and one Regulatory Verification Network validation submission.

### VII. Five Technical Properties That Software Cannot Provide

Property 1—Cryptographic Irreversibility. Forced re-keying with post-quantum key derivation destroys the baseline session key at the silicon level the moment a threshold violation is confirmed by quorum, making it physically impossible to generate compliant-state authorizations or proofs afterward. No software-only system can provide this because software key stores reside in memory accessible to processes capable of copying key material before destruction completes.
Property 2—Hardware-Rooted Temporal Ordering. Silicon-bound hardware monotonic counters across all quorum-participating instances provide tamper-resistant ordering of all governance events. Cross-instance counter verification means a single compromised instance cannot reorder events—the quorum detects the counter discrepancy and rejects the non-matching attestation.
Property 3—Third-Party-Verified Non-Repudiation. Risk-state-transition records bound to hardware-signed attestation reports, independently validated by Regulatory Verification Network nodes, create governance compliance evidence that cannot be forged, disputed, or manipulated between generation and regulatory review. No prior compliance evidence system in regulated financial markets provides this property.
Property 4—Privacy-Preserving Regulatory Verifiability. ZKP proofs allow Regulatory Verification Network nodes and regulatory portals to verify full governance compliance without accessing proprietary risk model parameters, treasury positions, voting weight distributions, or governance token holder identities, enabling regulatory supervision without commercial information asymmetries or privacy violations.
Property 5—Multi-Layer Hardware Defense. All governance-critical logic runs within enclave-protected memory using constant-time execution paths preventing timing side-channel attacks; multi-TEE quorum preventing single-enclave compromise; an on-chain attestation registry preventing counterfeit engine authorization; post-quantum signatures protecting the full attestation chain; and IOMMU-enforced network isolation at the hardware level. These five defense layers constitute a technical improvement to distributed governance computer systems impossible to achieve in software-only implementations, satisfying 35 U.S.C. § 101 under the 2025 Kim Memorandum and December 2025 Desjardins guidance.

What is claimed is:

1. A hardware-anchored governance system for decentralized governance systems operating in regulated financial or tokenized asset networks, comprising:
one or more processors executing within enclave-protected memory pages configured to establish a static enclave measurement during initialization cryptographically bound to a hardware root-of-trust element and to generate hardware-signed attestation reports incorporating an attestation report user-data field, wherein a Post-Quantum Attestation Layer applies post-quantum cryptographic signature algorithms selected from CRYSTALS-Dilithium, Falcon, or SPHINCS+to attestation report signing and verification, and applies CRYSTALS-Kyber key encapsulation to inter-TEE communications;
a TEE-resident governance platform operatively coupled to federated governance data sources including on-chain proposal feeds, off-chain treasury position data, and cross-chain exposure data ingested via Cross-Chain Interoperability Adapters executing within enclave-protected memory, with attestation verification across heterogeneous trusted execution environments comprising at least two distinct confidential computing architectures;
a Multi-TEE Quorum Verification Layer comprising at least three independent TEE instances each independently computing the risk assessment result for each governance proposal and cross-verifying enclave measurements, hardware monotonic counter values, and risk output hashes, wherein execution authorization is generated only upon cryptographic quorum agreement across a threshold number of participating instances with identical verified risk outputs under verified unmodified enclave measurements;
an On-Chain Attestation Registry comprising a smart contract deployed on at least one blockchain network storing approved static enclave measurements, queried by governance smart contracts before accepting execution authorization tokens, wherein tokens generated by engines with non-matching enclave measurements are structurally rejected, and wherein measurement updates require TEE-attested multi-signature quorum authorization;
a Regulatory Verification Network comprising independent verification nodes that autonomously validate TEE attestation reports by querying the On-Chain Attestation Registry to verify enclave measurements, verify hardware monotonic counter value sequences for temporal consistency, and independently confirm provenance ledger Merkle commitment chains, wherein compliance evidence package export is conditioned on receipt of Regulatory Verification Network node validation confirmations;
a TEE-resident AI risk assessment engine configured to evaluate governance proposals against one or more sealed compliance thresholds including at least one regulatory standard selected from Basel III/IV, MiCA, SEC, CFTC, FCA, or equivalent jurisdictional requirements, wherein thresholds are sealed in enclave-protected memory inaccessible to all external processes and all threshold evaluations employ constant-time execution paths;
a Proposal Gating Enforcer configured to condition on-chain execution authorization tokens on quorum-confirmed attested risk assessment outputs, wherein tokens carry attestation signatures of all quorum-participating instances and the On-Chain Attestation Registry measurement hash and are computationally infeasible to generate without both quorum agreement and post-transition session keys bound to compliant-state attestations;
an Evaluation-State Attestation Machine configured to execute, upon detection of a risk threshold violation confirmed by quorum agreement, an atomic four-step risk-state transition comprising: writing a risk-state-transition record into enclave-protected memory and incorporating it into the attestation report user-data field across all quorum-participating instances; atomically destroying the baseline session key and deriving a post-transition session key via post-quantum key derivation from the risk-degraded-state attestation within each participating TEE; incrementing hardware monotonic counters bound to silicon-level hardware across all participating instances; and activating IOMMU-enforced network isolation;
an Automated Treasury Safeguard module configured to activate concurrently with the Evaluation-State Attestation Machine, enforcing at least one of: automatic treasury asset freezes preventing withdrawal authorization token generation; graduated circuit-breaker withdrawal limits computed using blinded comparison operations proportional to risk threshold proximity; or pre-emptive insurance pool funding triggers authenticated with warning-state session keys derived from warning-state attestations distinct from compliant-state and risk-degraded-state attestations; all enforced through post-transition session key gating inside the TEE independently of any governance vote or administrative action;
an append-only provenance ledger configured to record governance events with tamper-evident quantum-resistant ledger commitments comprising SHA-3 family cryptographic hash chains bound to attestation report contents, hardware monotonic counter values, quorum participation confirmations, and Regulatory Verification Network node validation receipts, with post-quantum signatures applied to Merkle root exports; and
a Regulatory Verification Engine configured to assemble compliance evidence packages comprising hardware-signed attestation reports with post-quantum signatures, provenance ledger commitments, quorum agreement confirmations, and zero-knowledge proof outputs, formatted simultaneously for at least two regulatory frameworks selected from SEC, CFTC, MiCA, Basel IV, FCA, or FSB via jurisdiction-specific adaptation modules, wherein compliance evidence package export is structurally gated on hardware-signed attestation verification, quorum agreement confirmation, On-Chain Attestation Registry measurement verification, and Regulatory Verification Network node validation receipt; and a ZKP generator producing constant-size proofs encoding SHA-3 Merkle commitments, attestation user-data fields comprising risk-state-transition records, hardware monotonic counter values, and quorum participation confirmations as public inputs, wherein proof instantiation is cryptographically dependent on the post-transition session key such that generation of a valid proof before completion of the atomic transition is computationally infeasible.

2. A method for hardware-anchored governance of decentralized governance systems in regulated financial or tokenized asset networks, comprising:
initializing at least three TEE-resident governance platform instances within enclave-protected memory to establish static enclave measurements bound to hardware root-of-trust elements, publishing approved enclave measurements to an On-Chain Attestation Registry smart contract through TEE-attested multi-signature authorization, and registering Regulatory Verification Network nodes for independent validation;
ingesting federated governance data comprising at least one of on-chain proposal content, off-chain treasury position data, or cross-chain exposure data via Cross-Chain Interoperability Adapters executing within enclave-protected memory with attestation verification across heterogeneous trusted execution environments;
evaluating governance proposals across all participating TEE instances using TEE-resident AI risk assessment engines against sealed compliance thresholds including at least one regulatory standard selected from Basel III/IV, MiCA, SEC, CFTC, FCA, or equivalent jurisdictional requirements using constant-time execution paths, and establishing cryptographic quorum agreement before generating execution authorization tokens that carry attestation signatures of all quorum-participating instances and the On-Chain Attestation Registry measurement hash;
upon detection of a risk threshold violation confirmed by quorum, executing atomic four-step risk-state transitions across all participating TEE instances comprising: incorporating risk-state-transition records into hardware-signed attestation report user-data fields;
atomically destroying baseline session keys and deriving post-transition session keys via post-quantum key derivation from risk-degraded-state attestations; incrementing hardware monotonic counters; and activating IOMMU-enforced network isolation; and concurrently activating Automated Treasury Safeguards enforced through post-transition session key gating;
recording governance events in an append-only provenance ledger with SHA-3 quantum-resistant hash chains bound to attestation contents, quorum confirmations, and Regulatory Verification Network validation receipts, with post-quantum signatures applied to Merkle root exports; and
assembling compliance evidence packages gated on hardware-signed attestation verification, quorum confirmation, On-Chain Attestation Registry measurement verification, and Regulatory Verification Network validation, and generating ZKP proofs cryptographically dependent on post-transition session keys, formatted simultaneously for at least two regulatory frameworks.

3. One or more non-transitory computer-readable media storing instructions that, when executed by one or more processors operating within a Trusted Execution Environment, cause the processors to perform:
establishing a static enclave measurement cryptographically bound to a hardware root-of-trust element and publishing the enclave measurement to an On-Chain Attestation Registry smart contract through an attested provisioning channel;
participating in a Multi-TEE Quorum Verification Layer by ingesting governance data via Cross-Chain Interoperability Adapters within enclave-protected memory, independently computing risk assessment results using constant-time execution paths against sealed compliance thresholds, and cross-verifying enclave measurements, hardware monotonic counter values, and risk output hashes with at least two other TEE instances before contributing to quorum agreement;
conditioning execution authorization token generation on quorum-confirmed compliant-state attestations, wherein tokens carry attestation signatures of all quorum-participating instances and the On-Chain Attestation Registry measurement hash;
upon detection of a risk threshold violation confirmed by quorum, executing an atomic four-step risk-state transition comprising: incorporating a risk-state-transition record into a hardware-signed attestation report user-data field; atomically destroying the baseline session key and deriving a post-transition session key via post-quantum key derivation;
incrementing a hardware monotonic counter; and activating IOMMU-enforced network isolation; and concurrently activating Automated Treasury Safeguards through post-transition session key gating;
recording governance events in an append-only quantum-resistant provenance ledger with post-quantum signatures on Merkle root exports and providing attestation reports, monotonic counter values, and ledger Merkle commitments to Regulatory Verification Network nodes for independent validation; and
assembling compliance evidence packages with ZKP proofs cryptographically dependent on post-transition session keys, gated on Regulatory Verification Network validation receipt, formatted simultaneously for at least two regulatory frameworks.

4. The system of claim 1, wherein the Multi-TEE Quorum Verification Layer spans TEE instances from at least two distinct hardware vendors or cloud providers selected from Intel SGX, AMD SEV-SNP, Intel TDX, ARM TrustZone, AWS Nitro Enclaves, and Azure Confidential Virtual Machines, and wherein provider-specific attestation report formats are normalized to a common internal representation by the Regulatory Verification Engine cross-provider adaptation layer for consistent quorum cross-verification.

5. The system of claim 1, wherein the On-Chain Attestation Registry smart contract is deployed on at least two distinct blockchain networks for redundancy, and wherein governance smart contracts on each target blockchain independently query the registry instance on their own network before accepting any execution authorization token, extending registry-based verification to every blockchain on which the DAO operates.

6. The system of claim 1, wherein the Regulatory Verification Network nodes are operated by at least one entity selected from a regulatory authority, designated independent auditor, or institutional counterparty, and wherein each node independently queries the On-Chain Attestation Registry to verify the enclave measurement before validating any attestation report, creating an end-to-end independently verifiable chain from silicon-level enclave measurement through regulatory compliance confirmation.

7. The system of claim 1, wherein the Post-Quantum Attestation Layer applies CRYSTALS-Dilithium signatures providing security against Shor's algorithm attacks on classical signature schemes to all attestation report exports and Merkle root exports, and applies CRYSTALS-Kyber key encapsulation to all inter-TEE communications within the Multi-TEE Quorum Verification Layer, ensuring cryptographic security of the compliance evidence pipeline across the multi-decade regulatory retention periods required by SEC Rule 17a-4, CFTC Regulation 1.31, and MiCA governance documentation obligations.

8. The system of claim 1, wherein the Automated Treasury Safeguard module's graduated circuit-breaker withdrawal limits are computed using blinded comparison operations against sealed threshold proximity boundaries that do not reveal sealed threshold values to external observers, and are enforced through time-locked post-transition authorization token issuance in which maximum withdrawal amounts decrease proportionally to the computed risk score proximity distance.

9. The system of claim 1, wherein the Automated Treasury Safeguard module derives warning-state session keys from warning-state attestation reports that are cryptographically distinct from both compliant-state and risk-degraded-state attestations, using the warning-state session key to authenticate pre-emptive on-chain insurance pool funding calls when risk scores exceed a configurable early-warning threshold below the hard compliance threshold boundary.

10. The system of claim 1, wherein the Cross-Chain Interoperability Adapters normalize governance state and treasury exposure data from at least two blockchain networks selected from Ethereum mainnet, Ethereum Layer 2 rollup networks, Avalanche, Polygon, Solana, Hyperledger Fabric, and R3 Corda, with each cross-chain data contribution cryptographically bound to the attestation report of the normalizing TEE instance and recorded in the provenance ledger with source blockchain network, cross-chain bridge protocol, and attestation verification status fields.

11. The system of claim 1, wherein the sealed compliance thresholds comprise at least one of: a Basel IV Liquidity Coverage Ratio minimum threshold; a Basel IV Net Stable Funding Ratio minimum threshold; a MiCA Article 45 reserve asset composition threshold; an SEC Rule 206(4)-2 qualified custodian safeguard threshold; a CFTC commodity pool operator position limit threshold; or an FCA Financial Services and Markets Act 2023 cryptoasset governance requirement.

12. The system of claim 1, wherein the ZKP generator employs Groth16 proof constructions producing constant-size proofs for sub-millisecond regulatory portal verification in preferred embodiments, or STARK-based proof constructions providing full post-quantum resistance through exclusive reliance on SHA-3 hash function collision hardness without trusted setup requirements in alternative embodiments, with the proof construction configurable per jurisdiction.

13. The system of claim 1, wherein the append-only provenance ledger employs SHA3-256 for individual governance event entry hashing and SHA3-512 for Merkle root computation, with post-quantum CRYSTALS-Dilithium or SPHINCS+signatures applied to all Merkle root exports transmitted to Regulatory Verification Network nodes and included in compliance evidence packages.

14. The system of claim 1, wherein reversion to baseline compliant operational state requires complete TEE reinitialization across all quorum-participating instances destroying all session keys and resetting attestation state, followed by re-publication of updated enclave measurements to the On-Chain Attestation Registry through a new TEE-attested multi-signature update transaction requiring quorum agreement from the reinitializing instances.

15. The system of claim 1, wherein the Regulatory Verification Engine jurisdiction-specific adaptation modules simultaneously format compliance evidence packages for at least three frameworks selected from: a SEC adapter for Form PF, Form ADV, and Schedule D electronic submission; a CFTC adapter for Regulation 4.22 and NFA compliance filing; a MiCA adapter for ESMA Articles 68 through 76 governance documentation; a Basel IV adapter for EBA and BCBS Pillar III disclosure reporting; an FCA adapter for the UK Financial Services and Markets Act 2023 cryptoasset regime; or an FSB adapter for global systemically important institution cross-border governance reporting; wherein all adapters operate from a single ZKP proof computation and a single Regulatory Verification Network validation receipt.

16. The system of claim 1, wherein risk-weighted governance proposal advancement is modulated such that proposals within a configurable proximity band of compliance threshold boundaries trigger automated escalation notifications to designated human governance participants with escalation events recorded in the provenance ledger and confirmed by Regulatory Verification Network nodes, and wherein proximity distances are computed using blinded operations that do not disclose sealed threshold values to external observers.

17. The system of claim 1, wherein the TEE-resident governance platform enforces a unified cryptographic governance state across a multi-chain DAO such that compliance evidence for proposals spanning multiple blockchain networks is cryptographically bound to a common attestation-anchored governance state verified by quorum agreement across all participating TEE instances, on-chain execution authorization is conditioned on compliant risk-state attestations verified for all affected blockchain networks simultaneously with authorization tokens confirmed against the On-Chain Attestation Registry on each target network, and provenance ledger entries for all cross-chain governance events are Merkle-committed to a single attestation-anchored root with post-quantum signatures enabling unified multi-jurisdictional regulatory evidence from a single ZKP proof set validated by a single Regulatory Verification Network submission.
